(19) United States
(12) Patent Application Publication
(10) Pub. No.: US 2009/0202867 A1
(43) Pub. Date: Aug. 13, 2009

(54) PROCESS FOR PRODUCING MAGNETIC METAL PARTICLES FOR MAGNETIC RECORDING, AND MAGNETIC RECORDING MEDIUM

(75) Inventors: Mineko Ohsugi, Hiroshima-ken (JP); Toshiharu Harada, Yamaguchi-ken (JP); Takahiro Matsuo, Yamaguchi-ken (JP); Yosuke Yamamoto, Yamaguchi-ken (JP); Kazuyuki Hayashi, Hiroshima-ken (JP)

Correspondence Address: NIXON & VANDERHYE, PC, 901 NORTH GLEBE ROAD, 11TH FLOOR, ARLINGTON, VA, 22203, US

(73) Assignee: TODA KOGYO CORPORATION, Hiroshima-ken (JP)

(21) Appl. No.: 12/364,658

(22) Filed: Feb. 3, 2009

(30) Foreign Application Priority Data
Feb. 6, 2008 (JP) 2008-26265

(51) Int. Cl. G11B 5/706; H01F 1/01

(52) U.S. Cl. 428/846; 252/62.58

(57) ABSTRACT

The present invention relates to a process for producing magnetic metal particles for magnetic recording, comprising:
heat-treating goethite particles having an aluminum content of 4 to 50 atom % in terms of Al based on whole Fe to obtain hematite particles; and
heat-reducing the hematite particles at a temperature of 200 to 600° C.,
the goethite particles being obtained by adding a peroxodisulfate to a reaction solution comprising:
   a ferrous salt aqueous solution and
   a mixed alkali aqueous solution comprising:
      an alkali hydrogen carbonate aqueous solution or alkali carbonate aqueous solution and
      an alkali hydroxide aqueous solution
         before initiation of an oxidation reaction of the reaction solution, and then conducting the oxidation reaction.

### BACKGROUND OF THE INVENTION

The present invention relates to magnetic metal particles which are prevented from suffering from agglomeration thereof and capable of providing a magnetic coating film having excellent magnetic properties (coercive force Hc) in spite of fine particles, in particular, those particles having an average major axis diameter as small as 5 to 100 nm.

In recent years, miniaturization, lightening, recording-time prolongation and high-density recording as well as increase in memory capacity in magnetic recording and reproducing apparatuses for computers, etc., have proceeded more rapidly. With such a recent tendency, it has been increasingly required to provide magnetic recording media having a high performance and a high-density recording property, such as magnetic tapes and magnetic disks.

Namely, the magnetic recording media have been required to have high image definition and quality, and high output characteristics such as, in particular, good frequency characteristics. For this reason, it has been required that the magnetic recording media are reduced in noise due to the magnetic recording media themselves, and exhibit a high coercive force Hc and an excellent switching field distribution (S.F.D.).

These properties of the magnetic recording media have a close relation to magnetic particles used therein. Therefore, it has also been strongly required to further improve properties of magnetic metal particles containing iron as a main component.

More specifically, in order to obtain magnetic recording media satisfying various properties mentioned above, the magnetic metal particles containing iron as a main component which are used as magnetic particles in the magnetic recording media have been strongly required to be in the form of fine particles, and to exhibit a higher coercive force Hc.

As to the reduction in particle size of the magnetic metal particles, in order to obtain magnetic recording media having high output characteristics in a short wavelength region as well as a lessened noise, it is necessary to reduce the particle size of the magnetic metal particles, i.e., reduce a major axis diameter thereof to obtain fine particles.

Also, in recent years, it has been attempted to use a magneto-resistance type head as a reproduction head for computer tapes instead of conventional induction-type magnetic heads. The magneto-resistance type head can readily produce a high reproduction output as compared to the conventional induction-type magnetic heads, and is free from impedance noise due to use of induction coil. Therefore, the use of the magneto-resistance type head contributes to reduction in a system noise to a large extent. In consequence, if such noises due to the magnetic recording media themselves are reduced, it will be possible to attain a high C/N ratio. Accordingly, in order to reduce such magnetic recording media noises, in particular, noises due to particles, it has been required to further reduce the particle size of the magnetic metal particles used therein.

However, since the reduction in particle size of the magnetic metal particles is accompanied with increase in proportion of an oxidation layer in the whole particles, the coercive force Hc of the magnetic metal particles tends to be deteriorated owing to formation of the oxidation layer. Therefore, in order to obtain excellent magnetic recording media, it has been required to provide magnetic metal particles exhibiting a high coercive force Hc in spite of fine particles.

Conventionally, as the process for producing goethite particles as a precursor of the magnetic metal particles, there are known the production process using hydrogen peroxide, etc., (Japanese Patent Application Laid-open (KOKAI) Nos. 5-270836 (1993), 5-310431 (1993) and 2007-81227), and the production process in which various conditions of production reaction of the goethite particles such as temperature, deaggregation and stirring are suitably controlled (Japanese Patent Application Laid-open (KOKAI) No. 2005-277094).

### SUMMARY OF THE INVENTION

Although it has now been required to provide magnetic metal particles exhibiting a high coercive force Hc in spite of fine particles, the magnetic metal particles containing iron as a main component which fully satisfy various properties mentioned above are not obtained until now.

That is, the conventional techniques described in the above references have failed to obtain the magnetic metal particles having a high coercive force Hc in spite of fine particles.

In consequence, an object of the present invention is to provide magnetic metal particles having excellent magnetic properties (coercive force Hc) although they are in the form of fine particles having an average major axis diameter as small as 5 to 100 nm.

The above object of the present invention can be achieved by the following subject matters of the present invention.

In a first invention, there is provided a process for producing magnetic metal particles for magnetic recording, comprising:

heat-treating goethite particles having an aluminum content of 4 to 50 atom % in terms of Al based on whole Fe to obtain hematite particles; and

heat-reducing the hematite particles at a temperature of 200 to 600° C., the goethite particles being obtained by adding a peroxodisulfate to a reaction solution comprising:
a ferrous salt aqueous solution and
a mixed alkali aqueous solution comprising:
   an alkali hydrogen carbonate aqueous solution or alkali carbonate aqueous solution and
   an alkali hydroxide aqueous solution
      before initiation of an oxidation reaction of the reaction solution, and then conducting the oxidation reaction.

In a second invention, there is provided a process according to the first invention, wherein the goethite particles further comprise Co in an amount of 10 to 50 atom % based on whole Fe.

In a third invention, there is provided a process according to the second invention, wherein a surface of the goethite particles produced is coated with a rare earth compound and/or a Co compound, and then the thus coated goethite particles are subjected to the heat treatment.

In a fourth invention, there is provided a process according to the third invention, wherein the rare earth compound is used such that a coating amount thereof is 10 to 30 atom % in terms of rare earth element based on whole Fe.

In a fifth invention, there is provided a process according to the third invention, wherein the Co compound is used such that a coating amount thereof is 20 to 200 atom % in terms of Co based on whole Co contained in the goethite particles before the coating treatment.

In a sixth invention, there is provided a process according to the first invention, wherein the peroxodisulfate is added in an amount of 0.5 to 5 mol % in terms of peroxodisulfate based on whole Fe.

In a seventh invention, there is provided a process according to the first invention, wherein the peroxodisulfate is ammonium peroxodisulfate.

In an eighth invention, there is provided a magnetic recording medium, comprising:

a non-magnetic substrate;

a non-magnetic undercoat layer formed on the non-magnetic substrate, comprising non-magnetic particles and a binder resin;

and

a magnetic recording layer formed on the non-magnetic undercoat layer, comprising magnetic particles and a binder resin,

the magnetic metal particles for magnetic recording produced by the process as defined in the first aspect being used as the magnetic particles.

### DETAILED DESCRIPTION OF THE INVENTION

The present invention is described in detail below.

First, the process for producing magnetic metal particles for magnetic recording according to the present invention is described.

According to the present invention, in the process for producing magnetic metal particles which includes the steps of heat-treating goethite particles having an aluminum content of 4 to 40 atom % in terms of Al based on whole Fe to obtain hematite particles and then subjecting the resulting hematite particles to heat reduction at a temperature of 300 to 600° C., the goethite particles used in the above process are obtained by adding a peroxodisulfate to a reaction solution comprising a ferrous salt aqueous solution and a mixed alkali aqueous solution of: an alkali hydrogen carbonate aqueous solution or an alkali carbonate aqueous solution, and an alkali hydroxide aqueous solution before initiation of an oxidation reaction thereof, and then subjecting the resulting mixture to oxidation reaction.

The process for producing the goethite particles is described in more detail below.

The goethite particles used in the present invention are obtained by first producing spindle-shaped goethite seed crystal particles and then growing a goethite layer on the surface of the respective goethite seed crystal particles. Upon producing the spindle-shaped goethite seed crystal particles, the peroxodisulfate is used as an oxidizing agent.

The spindle-shaped goethite seed crystal particles are obtained by the steps of reacting a mixed alkali aqueous solution of an alkali hydrogen carbonate aqueous solution or an alkali carbonate aqueous solution, and an alkali hydroxide aqueous solution with a ferrous salt aqueous solution to obtain a water suspension containing a ferrous-containing precipitate; aging the water suspension containing the ferrous-containing precipitate in a non-oxidative atmosphere; and passing an oxygen-containing gas through the water suspension to conduct an oxidation reaction thereof, thereby producing the aimed spindle-shaped goethite seed crystal particles, wherein before initiation of the oxidation reaction, a Co compound and then the peroxodisulfate as an oxidizing agent are successively added to the water suspension containing the ferrous-containing precipitate during aging thereof, and then the resulting mixture is subjected to oxidation reaction.

Thereafter, when an oxidation percentage (Fe²⁺/whole Fe) of the reaction solution in the oxidation reaction reaches 20% or more, an Al compound is added to the water suspension, and the resulting mixture is successively subjected to oxidation reaction as growth reaction, thereby obtaining the goethite particles.

The aging of the water suspension is suitably conducted at a temperature of 40 to 80° C. in a non-oxidative atmosphere. When the aging temperature is less than 40° C., the resulting particles tend to have a small aspect ratio, and it may be therefore difficult to attain a sufficient aging effect. When the aging temperature is more than 80° C., magnetite tends to be mixed in the obtained particles. The aging time is usually 30 to 300 min. When the aging time is less than 30 min or more than 300 min, it may be difficult to obtain the particles having the aimed aspect ratio. In order to produce the non-oxidative atmosphere, an inert gas (such as nitrogen gas) or a reducing gas (such as hydrogen gas) may be passed and flowed through an inside of a reactor receiving the above suspension.

As the ferrous salt aqueous solution used in the production reaction of the spindle-shaped goethite seed crystal particles, there may be used a ferrous sulfate aqueous solution, a ferrous chloride aqueous solution, etc. These ferrous salt aqueous solutions may be used alone or in the form of a mixture of any two or more thereof, if required.

The mixed alkali aqueous solution used in the production reaction of the spindle-shaped goethite seed crystal particles may be obtained by mixing an alkali hydrogen carbonate aqueous solution or an alkali carbonate aqueous solution with an alkali hydroxide aqueous solution. In this case, the mixing ratio (expressed by % in terms of normality) between the alkali carbonate aqueous solution and the alkali hydroxide aqueous solution is controlled such that the alkali hydroxide aqueous solution is preferably used in the mixed solution in an amount of 10 to 40% and more preferably 15 to 35% (all expressed by % in terms of normality). When the amount of the alkali hydroxide aqueous solution used in the mixed solution is less than 10%, it may be difficult to obtain particles having the aimed aspect ratio. When the amount of the alkali hydroxide aqueous solution used in the mixed solution is more than 40%, granular magnetite tends to be mixed in the obtained particles.

As the above alkali hydrogen carbonate aqueous solution, there may be used a sodium hydrogen carbonate aqueous solution, a potassium hydrogen carbonate aqueous solution, an ammonium hydrogen carbonate aqueous solution, etc. As the above alkali carbonate aqueous solution, there may be used a sodium carbonate aqueous solution, a potassium carbonate aqueous solution, an ammonium carbonate aqueous solution, etc. As the alkali hydroxide aqueous solution, there may be used a sodium hydroxide aqueous solution, a potassium hydroxide aqueous solution, an ammonium hydroxide aqueous solution, etc. These aqueous solutions may be respectively used alone or in the form of a mixture of any two or more thereof, if required.

The amount of the mixed alkali aqueous solution used is 1.3 to 3.5 and preferably 1.5 to 2.5 in terms of an equivalent ratio based on whole Fe in the ferrous salt aqueous solution. When the amount of the mixed alkali aqueous solution used is less than 1.3, magnetite tends to be mixed in the obtained particles. It may be industrially undesirable to use the mixed alkali aqueous solution in an amount of more than 3.5.

The ferrous concentration in the mixture obtained after mixing the ferrous salt aqueous solution with the mixed alkali aqueous solution is preferably 0.1 to 1.0 mol/L and more preferably 0.2 to 0.8 mol/L. When the ferrous concentration is less than 0.1 mol/L, the yield of the aimed product tends to be lowered, resulting in industrially disadvantageous process. When the ferrous concentration is more than 1.0 mol/L, the particle size distribution of the obtained particles tends to be undesirably broad.

When the Co compound is added subsequent to the time at which 50% of the whole aging time elapses, it may be difficult to obtain particles having the aimed particle size and aspect ratio.

Examples of the Co compound to be added in the production reaction of the spindle-shaped goethite seed crystal particles include cobalt sulfate, cobalt chloride and cobalt nitrate. These Co compounds may be used alone or in the form of a mixture of any two or more thereof, if required.

The amount of the Co compound added in the production reaction of the seed crystal particles is preferably 10 to 50 atom % based on whole Fe.

The pH value of the reaction solution in the production reaction of the spindle-shaped goethite seed crystal particles is preferably in the range of 8.0 to 11.5 and more preferably 8.5 to 11.0. When the pH value is less than 8.0, a large amount of acid radicals tend to be mixed in the goethite particles. Since such acid radicals are not easily removed by washing, sintering between the particles tends to be caused upon producing the aimed magnetic metal particles therefrom. When the pH value is more than 11.5, the particles having the aimed coercive force tend to be hardly produced.

In the production reaction of the spindle-shaped goethite seed crystal particles, first, a peroxodisulfate as an oxidizing agent is added to the reaction solution. When the peroxodisulfate is added in the course of the oxidation reaction, it may be difficult to attain the effect of well controlling the particle size distribution of the obtained particles.

Examples of the peroxodisulfate include ammonium peroxodisulfate, potassium peroxodisulfate, sodium peroxodisulfate, potassium hydrogen peroxodisulfate and sodium hydrogen peroxodisulfate and ammonium peroxodisulfate. Among these peroxodisulfates, preferred is ammonium peroxodisulfate. In particular, combination of ammonium peroxodisulfate as the oxidizing agent, an ammonium carbonate aqueous solution as the alkali carbonate aqueous solution and an ammonium hydroxide aqueous solution as the alkali hydroxide aqueous solution, is preferably used because no alkali metals, etc., are present in the reaction solution so that the resulting goethite particles comprise no impurities such as alkali metals.

The amount of the peroxodisulfate added as the oxidizing agent is 0.5 to 5 mol % in terms of peroxodisulfate based on whole Fe. When the amount of the peroxodisulfate added is less than 0.5 mol %, seed crystals of the particles tend to be unevenly produced. As a result, growth of the particles tends to become uneven owing to residual growing components, thereby failing to obtain particles having a good particle size distribution. When the amount of the peroxodisulfate added is more than 5 mol %, the effect of addition of the oxidizing agent tends to be saturated, and therefore the addition of such a large amount of the oxidizing agent may be meaningless. The amount of the peroxodisulfate added is more preferably 1.0 to 4.0 mol %. The peroxodisulfate may be added either in a form of aqueous solution or as a solid (powder) as it is.

Next, an oxygen-containing gas (for example, air) is passed through the reaction solution to conduct an oxidation reaction thereof.

The superficial velocity of the oxygen-containing gas is preferably 2.3 to 3.5 cm/s. When the superficial velocity of the oxygen-containing gas is less than 2.3 cm/s, the oxidation reaction rate tends to be too low, so that granular magnetite tends to be mixed in the obtained particles, and it may be difficult to control the particle size thereof to the aimed value. On the other hand, when the superficial velocity of the oxygen-containing gas is more than 3.5 cm/s, the oxidation reaction rate tends to be too high, so that it may be difficult to control the particle size of the obtained particles to the aimed value. Meanwhile, the superficial velocity as used herein means an amount of the oxygen-containing gas passed and flowed per unit sectional area (the bottom sectional area of a cylindrical column reactor, the pore diameter of a perforated plate and the number of pores are not taken into consideration), and its unit is expressed by cm/sec.

The production reaction of the spindle-shaped goethite seed crystal particles may be conducted at a temperature of not more than 80° C. When the production reaction temperature is more than 80° C., magnetite may be mixed in the obtained goethite particles. The production reaction temperature is preferably in the range of 40 to 70° C.

The pH value in the growth reaction of the goethite layer is usually in the range of 8.0 to 11.5 and preferably 8.5 to 11.0. When the pH value is less than 8.0, a large amount of acid radicals tend to be mixed in the goethite particles and cannot be easily removed even by washing, so that sintering of the resulting magnetic metal particles may be caused. On the other hand, when the pH value is more than 11.5, the resulting magnetic metal particles may fail to attain the aimed particle size distribution.

The growth reaction of the goethite layer is conducted through oxidation reaction by passing an oxygen-containing gas (e.g. air) through the reaction solution. It is preferred that the superficial velocity of the oxygen-containing gas passed upon the growth reaction be larger than that in the production reaction of the seed crystal particles. When the superficial velocity upon the growth reaction is not larger than that upon the production reaction, the viscosity of the water suspension tends to be increased when adding Al thereto, and the growth in the minor axis direction of the particles tends to be more promoted, so that the aspect ratio tends to be decreased, thereby failing to obtain particles having the aimed aspect ratio. However, when the superficial velocity in the production reaction of the seed crystal particles is not less than 2.0 cm/s, it is not required that the superficial velocity in the growth reaction is lager than that in the production reaction.

The temperature used in the growth reaction of the goethite layer may be not more than 80° C. at which goethite particles are formed. When the growth reaction temperature is more than 80° C., magnetite tends to be mixed in the obtained goethite particles. The growth reaction temperature is preferably in the range of 40 to 70° C.

Examples of the Al compound added in the growth reaction of the goethite layer includes acid salts such as aluminum sulfate, aluminum chloride and aluminum nitrate, and aluminates such as sodium aluminate, potassium aluminate and ammonium aluminate. These Al compounds may be used alone or in the form of a mixture of any two or more thereof, if required.

The Al compound may be added at the time at which the oxidation percentage (Fe²⁺/whole Fe) of the reaction solution lies in the range of 20 to 90%.

The Al compound may be added at the same time when the superficial velocity of the oxygen-containing gas is preferably increased as compared with that in the production reaction of the seed crystal particles. When the Al compound is added over a prolonged period of time, the oxygen-containing gas may be replaced with a nitrogen-containing gas so as not to promote the oxidation reaction.

The amount of the Al compound added is 4 to 50 atom % based on the whole Fe contained in the goethite particles as the final product. When the amount of the Al compound added is less than 4 atom %, it may be difficult to attain a sufficient anti-sintering effect, thereby failing to maintain a good shape of the fine particles. When the amount of the Al compound added is more than 50 atom %, the resulting particles tend to exhibit a relatively small aspect ratio, so that it may be difficult to well control a coercive force thereof.

Next, the coating treatment of the goethite particles is described.

In the present invention, the surface of the respective goethite particles is coated with a rare earth compound and a Co compound by an ordinary method to produce starting particles for the subsequent heat treatment.

As the rate earth compound, there may be suitably used compounds of at least one rare earth element selected from scandium, yttrium, lanthanum, cerium, praseodymium, neodymium and samarium. The rare earth compound may be in the form of a chloride, a sulfate and a nitrate of these rare earth elements.

As the Co compound, there may be suitably used the Co compounds described in the above production reaction of the spindle-shaped goethite seed crystal particles.

The coating treatment may be conducted by either a dry method or a wet method, and is preferably conducted by a wet method.

The amount of the rare earth compound added is preferably 10 to 30 atom % in terms of rare earth element based on the whole Fe.

The Co compound is preferably added in such an amount that the coating amount of Co lies in the range of 20 to 200% based on the total amount of Co contained in the goethite particles produced (sum of Co in seed crystals and Co in the goethite layer formed in the growth reaction). When the coating amount of Co is more than 200%, it may be difficult to uniformly coat the particles with Co owing to excessive amount of Co added, so that the Co compound tends to be singly precipitated, and further the resulting magnetic metal particles tend to be deteriorated in magnetic properties. When the coating amount of Co is less than 20%, it may be difficult to attain the effects of the addition of Co according to the present invention owing to the less coating amount of Co.

When the goethite particles are coated with not only the rare earth compound but also the Co compound, the resulting coated goethite particles are prevented from undergoing sintering within and between the particles upon the heat treatment, so that it is possible to obtain hematite particles which more closely maintain and inherit a particle shape and an aspect ratio of the goethite particles. This allows magnetic metal particles containing iron as a main component which retain and inherit the particle shape or the like and are in the form of individual separate particles, to be readily produced from the hematite particles.

The surface-coated goethite particles used in the present invention have a spindle shape, comprise Co in an amount of 10 to 50 atom % (as a total amount of Co contained within the particles and Co coated thereon) based on the whole Fe, and comprise Al in an amount of 4 to 50 atom % based on the whole Fe.

The surface-coated goethite particles used in the present invention preferably have an average major axis diameter of 0.03 to 0.10 μm and an aspect ratio (average major axis diameter/average minor axis diameter) of 5 to 10. The goethite particles preferably have a BET specific surface area of 150 to 300 m²/g.

Next, the surface-coated goethite particles are subjected to heat dehydration treatment in a non-reducing gas atmosphere to obtain the hematite particles.

As the non-reducing atmosphere, there may be used a flow of at least one gas selected from the group consisting of air, oxygen gas and nitrogen gas. The heat-treating temperature used in the heat dehydration treatment is usually 100 to 650° C. The heat-treating temperature may be appropriately varied and selected from the above-specified range depending upon the kinds of compounds used upon the coating treatments of the spindle-shaped goethite particles. When the heat-treating temperature is less than 100° C., the heat dehydration treatment may require a prolonged period of time. When the heat-treating temperature is more than 650° C., deformation of the particles and sintering within or between the particles tend to occur.

Next, the hematite particles are subjected to heat-reduction treatment.

The reducing apparatus preferably used in the present invention includes those in which a fixed bed is formed. More specifically, there are preferably used a standing-type reducing apparatus (batch type) and a movable reducing apparatus (continuous type) in which the reducing treatment is conducted while transporting a belt on which the fixed bed is formed.

The fixed bed used in the present invention preferably has a height of not more than 30 cm. When the height of the fixed bed is more than 30 cm, although a remarkable reduction-promoting effect is obtained because of a large content of Co therein, the water vapor partial pressure tends to be simultaneously increased owing to rapid reduction in a lower layer of the fixed bed, thereby causing problems such as deterioration in coercive force of the particles present in an upper layer of the fixed bed and, therefore, deterioration in properties of the particles as a whole. From the viewpoint of a good industrial productivity, the height of the fixed bed is more preferably 3 to 30 cm. Meanwhile, since the batch type (as described in Japanese Patent Application Laid-open (KOKAI) Nos. 54-62915 (1979) and 4-224609 (1992), etc.) is different in productivity from the continuous type (as described in Japanese Patent Application Laid-open (KOKAI) No. 6-93312 (1994), etc.), the height of the fixed bed formed in the batch type fixed bed reducing apparatus is preferably more than 4 cm and not more than 30 cm.

In the present invention, the heat-reducing temperature is preferably in the range of 300 to 700° C. When the heat-reducing temperature is less than 300° C., the reduction reaction tends to proceed too slowly, resulting in prolonged reaction time. Further, since crystal growth of the magnetic metal particles is insufficient, the resulting particles tend to be deteriorated in magnetic properties such as saturation magnetization and coercive force. When the heat-reducing temperature is more than 700° C., the reduction reaction tends to proceed too rapidly, thereby causing deformation of the particles as well as sintering within or between the particles.

The magnetic metal particles according to the present invention which are obtained after the heat-reduction treatment may be taken out in air by known methods, for example, by immersing the particles in an organic solvent such as toluene; by temporarily replacing the atmosphere existing around the magnetic metal particle obtained after the reduction reaction, with an inert gas, and then gradually increasing an oxygen content in the inert gas until it finally becomes air; by gradually oxidizing the particles using a mixed gas of oxygen and water vapor; or the like.

In the present invention, it is preferred that the heat-reduction treatment and the surface oxidation treatment are respectively repeated two times.

More specifically, the hematite particles are subjected to the first heat-reduction treatment at a temperature of 300 to 650° C. to obtain magnetic metal particles. The thus obtained magnetic metal particles are then subjected to the first surface oxidation treatment at a temperature of 60 to 200° C. in an oxygen-containing inert gas atmosphere to form an oxidation layer on the surface of the respective magnetic metal particles. Further, the thus surface-oxidized magnetic metal particles are subjected to the second heat-reduction treatment at a temperature of 300 to 700° C., and the resulting magnetic metal particles are then subjected to the second surface oxidation treatment to form a surface oxidation layer thereon.

In the present invention, the atmosphere used during the period until reacting the respective treating temperatures of the first and second heat-reduction treatments may be either an inert gas atmosphere or a reducing gas atmosphere. Examples of the preferred inert gas atmosphere include nitrogen gas, helium gas and argon gas. Among these inert gases, more preferred is nitrogen gas. When the treating temperature is rapidly raised for not more than 40 min and preferably not more than 20 min in the reducing gas atmosphere, the reducing temperature upon production of the magnetic metal particles can be kept constant.

Meanwhile, the temperature rise rate in the first and second heat-reduction treatments in the reducing atmosphere is preferably 20 to 100° C./min.

In the present invention, the atmosphere used in the first and second heat-reduction treatments is preferably a reducing gas. As the reducing gas, hydrogen is preferably used.

The heat-reducing temperature used in the first heat-reduction treatment in the present invention is 300 to 650° C. and preferably 350 to 650° C. The heat-reducing temperature may be suitably selected from the above-specified range depending upon kinds and amounts of the compounds used in the coating treatment of the starting material. When the heat-reducing temperature is less than 300° C., the reduction reaction tends to proceed very slowly and, therefore, is undesirable from the industrial viewpoint, so that the resulting magnetic metal particles tend to exhibit a low saturation magnetization. When the heat-reducing temperature is more than 650° C., the reduction reaction tends to proceed too rapidly, thereby causing destruction of shape of the particles as well as sintering within or between the particles which results in deteriorated coercive force of the obtained particles.

The superficial velocity of the reducing gas used in the first heat-reduction treatment in the present invention is preferably 40 to 150 cm/s. When the superficial velocity of the reducing gas is less than 40 cm/s, the water vapor generated by reduction of the starting material tends to be discharged out of the reaction system at a very slow rate, so that the upper layer of the fixed bed tends to be deteriorated in coercive force and S.F.D., thereby failing to obtain magnetic metal particles having a high coercive force as a whole. When the superficial velocity of the reducing gas is more than 150 cm/s, although the aimed magnetic metal particles are obtained, the reducing temperature required tends to be too high, so that there tend to arise problems such as scattering and breaking of the resulting granulated product.

In the present invention, the first surface oxidation treatment may be conducted in an oxygen-containing inert gas atmosphere. Examples of the preferred inert gas atmosphere include nitrogen gas, helium gas and argon gas. Among these inert gases, more preferred is nitrogen gas. The content of oxygen in the inert gas atmosphere is preferably 0.1 to 5 vol %, and the oxygen content is preferably gradually increased until reaching a predetermined amount.

The treating temperature used in the first surface oxidation treatment in the present invention is 40 to 200° C. and preferably 40 to 180° C. When the treating temperature used in the first surface oxidation treatment is less than 40° C., it may be difficult to form a surface oxidation layer having a sufficient thickness. When the treating temperature used in the first surface oxidation treatment is more than 200° C., the particles tend to suffer causing deformation of the particles, in particular, tend to be extremely swelled in the minor axis direction owing to production of a large amount of oxide, which tends to result in destruction of skeleton of the particles in the worse case.

Meanwhile, when the particles are oxidized as a whole in the first surface oxidation treatment, the particles tend to undergo change in skeleton thereof, in particular, growth thereof in the minor axis direction. As a result, the particles tend to be extremely swelled in the minor axis direction owing to production of a large amount of oxide, which tends to result in destruction of skeleton of the particles in the worse case. The particles which already suffer from such a destruction of the particle shape, are no longer improved in coercive force even when subjected to reduction reaction again.

The heat-reducing temperature used in the second heat-reduction treatment in the present invention is 300 to 700° C. When the heat-reducing temperature used in the second heat-reduction treatment is less than 300° C., the reduction reaction tends to proceed very slowly and, therefore, is undesirable from the industrial viewpoint, so that it may be difficult to reduce the surface oxidation layer formed in the first surface oxidation treatment and achieve densification of the particles as a whole. When the heat-reducing temperature used in the second heat-reduction treatment is more than 700° C., destruction of shape of the particles as well as sintering within or between the particles tend to be caused, resulting in deteriorated coercive force of the obtained particles. The heat-reducing temperature used in the second heat-reduction treatment is preferably 450 to 650° C.

The superficial velocity of the reducing gas used in the second heat-reduction treatment in the present invention is preferably 40 to 150 cm/s similarly to that used in the first heat-reduction treatment.

Meanwhile, the second heat-reduction treatment may be followed by annealing treatment. The treating temperature used in the annealing treatment is preferably 400 to 700° C. The atmosphere used in the annealing treatment is preferably hydrogen gas or an inert gas, in particular, nitrogen gas.

In the present invention, the second surface oxidation treatment may be conducted in an inert gas atmosphere comprising 5 to 10 g/m³ of water vapor and oxygen. When the content of water vapor in the inert gas atmosphere is less than 5 g/m³, it may be difficult to form a dense thin surface oxidation layer, and the resulting particles may fail to be sufficiently improved in coercive force. When the content of water vapor in the inert gas atmosphere is more than 10 g/m³, the aimed effects tend to be already saturated, and the inclusion of more than necessary amount of water vapor is meaningless. The content of water vapor in the inert gas atmosphere is preferably 2 to 8 g/m³. The content of oxygen in the inert gas atmosphere is preferably 0.1 to 5 vol %, and the oxygen content is preferably gradually increased until reaching a predetermined amount. Examples of the preferred inert gas include nitrogen gas, helium gas and argon gas. Among these inert gases, more preferred is nitrogen gas.

The treating temperature used in the second surface oxidation treatment in the present invention is 40 to 160° C. and preferably 40 to 140° C. Meanwhile, the reaction temperature used in the second surface oxidation treatment is preferably lower than that used in the first surface oxidation treatment.

Next, various properties of the magnetic metal particles which are obtained by the process for producing the magnetic metal particles according to the present invention are described.

The magnetic metal particles of the present invention are of a spindle shape and have an average major axis diameter of 5 to 100 nm. When the average major axis diameter is less than 5 nm, the magnetic metal particles tend to be rapidly deteriorated in oxidation stability and simultaneously tend to hardly exhibit high magnetic properties (coercive force Hc). When the average major axis diameter is more than 100 nm, the resulting magnetic metal particles tend to be unsuitable as magnetic particles for providing a magnetic recording medium exhibiting a high output and a reduced noise in a short wavelength region owing to a large particle size thereof. The average major axis diameter of the magnetic metal particles of the present invention is preferably 6 to 80 nm and more preferably 8 to 60 nm.

The magnetic metal particles of the present invention preferably have an aspect ratio of not less than 2.0. When the aspect ratio is less than 2.0, it may be impossible to obtain the magnetic metal particles having a high coercive force as aimed. The aspect ratio of the magnetic metal particles of the present invention is more preferably 3.0 to 8.0.

The magnetic metal particles of the present invention as behavior particles preferably have an average particle diameter of not more than 90 nm. In particular, when the average major axis diameter of the magnetic metal particles is 5 to 60 nm, the average particle diameter of the behavior particles of the magnetic metal particles is preferably 5 to 50 nm. When the average particle diameter of the behavior particles is more than 90 nm, the resulting particles tend to be increased in particle diameter owing to sintering within or between the particles, thereby failing to form a coating film having a sufficient surface smoothness. It is considered that such a problem is caused by sintering of the particles or stacking between the particles, thereby failing to attain good magnetic properties by orientation.

The magnetic metal particles of the present invention preferably have a BET specific surface area of 40 to 125 m²/g. When the BET specific surface area is less than 40 m²/g, it may be difficult to obtain magnetic metal particles satisfying a less noise and a good dispersibility. When the BET specific surface area is more than 120 m²/g, the resulting particles tend to be hardly dispersed upon forming a coating material, so that the obtained coating material tend to exhibit an undesirably high viscosity. The BET specific surface area of the magnetic metal particles is more preferably 70 to 110 m²/g.

The magnetic metal particles of the present invention preferably have a degree of denseness of 0.5 to 2.5. The degree of denseness of the magnetic metal particles is expressed by a ratio of a specific surface area S_{BET} as measured by BET method to a surface area S_{TEM} calculated from a major axis diameter and a minor axis diameter as measured from the particles observed on a microphotograph (S_{BET}/S_{TEM}).

When the ratio of S_{BET}/S_{TEM} is less than 0.5, although high densification of the particles is achieved, the resulting particles tend to be increased in particle diameter owing to sintering within or between the particles, so that it may be difficult to obtain a coating film having a sufficient surface smoothness. When the ratio of S_{BET}/S_{TEM} is more than 2.5, densification of the particles tends to be insufficient, so that a large number of dehydration pores tend to be formed inside of the particles or on the surface thereof, resulting in poor dispersibility in a vehicle. From the viewpoints of a good dispersibility in a vehicle and a good surface smoothness of the coating film, the ratio of S_{BET}/S_{TEM} is preferably 0.7 to 2.0 and more preferably 0.8 to 1.6.

The content of cobalt in the magnetic metal particles is preferably 20 to 50 atom % in terms of Co based on the whole Fe. When the content of cobalt in the magnetic metal particles is less than 20 atom %, the resulting particles tend to hardly exhibit a low saturation magnetization while keeping a good switching field distribution S.F.D., and may fail to exhibit a high coercive force. When the content of cobalt in the magnetic metal particles is more than 50 atom %, the resulting particles tend to have a low coercive force as well as tends to be deteriorated in saturation magnetization to more than necessary extent. The content of cobalt in the magnetic metal particles is more preferably 30 to 50 atom %.

The content of aluminum in the magnetic metal particles of the present invention is preferably 4 to 50 atom % in terms of Al based on the whole Fe. When the content of aluminum in the magnetic metal particles is less than the lower limit, the anti-sintering effect in the heat-reduction step tends to be lowered, so that the resulting particles tend to be deteriorated in coercive force, and exhibit a broad switching field distribution S.F.D. When the content of aluminum in the magnetic metal particles is more than the upper limit, the temperature required for the hydrogen reduction tends to be considerably high, resulting in undesirable production process. The content of aluminum in the magnetic metal particles is more preferably 6 to 40 atom %.

The content of rare earth element in the magnetic metal particles of the present invention is preferably 10 to 30 atom % in terms of rare earth element based on the whole Fe. When the content of rare earth element in the magnetic metal particles is less than the lower limit, the anti-sintering effect in the heat-reduction step tends to be lowered, so that the resulting particles tend to be deteriorated in coercive force, and exhibit a broad switching field distribution S.F.D. When the content of rare earth element in the magnetic metal particles is more than the upper limit, the temperature required for the hydrogen reduction tends to be considerably high, resulting in undesirable production process. The content of rare earth element in the magnetic metal particles is more preferably 15 to 28 atom %.

The magnetic metal particles of the present invention preferably have a crystallite size D₁₁₀ of 70 to 170 Å. When the crystallite size D₁₁₀ is less than 70 Å, although the magnetic recording medium using such particles is advantageous from the viewpoints of reduction in noise due to the particles, the resulting particles tend to be deteriorated in coercive force and exhibit a broad switching field distribution S.F.D., and further tend to be deteriorated in oxidation stability. When the crystallite size D₁₁₀ is more than 170 Å, the noise due to the particles tends to be undesirably increased. The crystallite size D₁₁₀ of the magnetic metal particles is more preferably 70 to 150 Å.

The soluble Na content in the magnetic metal particles is preferably not more than 30 ppm, more preferably not more than 20 ppm and still more preferably not more than 10 ppm. The soluble Ca content in the magnetic metal particles is preferably not more than 100 ppm, more preferably not more than 80 ppm and still more preferably not more than 70 ppm. When the contents of the above each impurity are more than the respective upper limits, the compounds derived from these impurities tend to be precipitated on the surface of the obtained magnetic coating film. Also, the content of residual sulfur in the magnetic metal particles is preferably not more than 60 ppm and more preferably not more than 50 ppm.

The coercive force Hc of the magnetic metal particles of the present invention is preferably 95.4 to 278.5 kA/m (1200 to 3500 Oe). When the coercive force Hc is less than 95.4 kA/m, the resulting magnetic recording medium tends to hardly exhibit a sufficient output in a short wavelength region. When the coercive force Hc is more than 278.5 kA/m, saturation of a recording head tends to be caused, thereby failing to attain the aimed high output in a short wavelength region. The coercive force Hc of the magnetic metal particles is more preferably 119.4 to 278.5 kA/m (1500 to 3500 Oe) and still more preferably 143.2 to 278.5 kA/m (1800 to 3500 Oe).

The saturation magnetization σs of the magnetic metal particles of the present invention is preferably 60 to 160 Am²/kg (60 to 160 emu/g). When the saturation magnetization as of the magnetic metal particles is less than 60 Am²/kg, the resulting magnetic recording medium tends to hardly exhibit a sufficiently high output in a short wavelength region owing to deteriorated residual magnetization, and the resulting magnetic metal particles may fail to have a high coercive force and a good switching field distribution S.F.D. When the saturation magnetization σs of the magnetic metal particles is more than 160 Am²/kg, saturation of a magneto-resistance head tends to be caused owing to excessive residual magnetization, and the resulting magnetic recording medium tends to suffer from distortion of reproduction properties and fail to exhibit a high C/N output in a short wavelength region. The saturation magnetization as of the magnetic metal particles of the present invention is more preferably 60 to 120 Am²/kg (60 to 120 emu/g) and still more preferably 70 to 110 Am²/kg (70 to 110 emu/g).

The magnetic metal particles of the present invention preferably have a squareness (σr/σs) of 0.48 to 0.55 and more preferably 0.49 to 0.54.

The magnetic metal particles of the present invention preferably have an oxidation stability Δσs of not more than 20% and more preferably not more than 15%.

The switching field distribution S.F.D. of a magnetic coating film obtained by using the magnetic metal particles of the present invention is preferably not more than 0.80. When S.F.D. of the magnetic coating film is more than 0.80, the region in which reversal of magnetization occurs tends to be expanded, so that the resulting magnetic recording medium tends to hardly exhibit a sufficient output in a short wavelength region. The switching field distribution S.F.D. of a magnetic coating film obtained by using the magnetic metal particles is more preferably not more than 0.75 and still more preferably not more than 0.70.

The coercive force Hc of a magnetic coating film obtained by using the magnetic metal particles of the present invention is preferably 111.4 to 278.5 kA/m (1400 to 3500 Oe) and more preferably 143.2 to 278.5 kA/m (1800 to 3500 Oe). The magnetic coating film obtained by using the magnetic metal particles of the present invention has a squareness (Br/Bm) of preferably not less than 0.65 and more preferably not less than 0.82, a surface roughness Ra of preferably not more than 4.0 nm and more preferably not more than 3.5, and an oxidation stability ΔBm of preferably less than 15%.

Next, the magnetic recording medium of the present invention is described.

The magnetic recording medium of the present invention comprises a non-magnetic substrate, and a magnetic recording layer formed on the non-magnetic substrate which comprises the magnetic metal particles of the present invention and a binder resin.

As the non-magnetic substrate, there may be used films of synthetic resins such as polyethylene terephthalate, polyethylene, polypropylene, polycarbonates, polyethylene naphthalate, polyamides, polyamide imides and polyimides, foils and plates of metals such as aluminum and stainless steel, and various papers which are presently generally used for production of magnetic recording media. The thickness of the non-magnetic substrate may vary depending upon materials thereof, and is usually 1.0 to 300 μm and preferably 2.0 to 50 μm.

The non-magnetic substrate for magnetic disks is usually formed from polyethylene terephthalate, and the thickness of the non-magnetic substrate for magnetic disks is usually 50 to 300 μm. The non-magnetic substrate for magnetic tapes which is formed from polyethylene terephthalate usually has a thickness of 3 to 100 μm. The non-magnetic substrate for magnetic tapes which is formed from polyethylene naphthalate usually has a thickness of 3 to 50 μm. The non-magnetic substrate for magnetic tapes which is formed from polyamides usually has a thickness of 2 to 10 μm.

Examples of the binder resin include those which are presently generally used for production of magnetic recording media, such as vinyl chloride-vinyl acetate copolymers, urethane resins, vinyl chloride-vinyl acetate-maleic acid copolymers, urethane elastomers, butadiene-acrylonitrile copolymers, polyvinyl butyral, cellulose derivatives such as nitrocellulose, polyester resins, synthetic rubber-based resins such as polybutadiene, epoxy resins, polyamide resins, polyisocyanates, electron beam-curable acrylic urethane resins, and mixture thereof.

Also, the respective binder resins may comprise polar groups such as —OH, —COOH, —SO₃M, —OPO₂M₂ and —NH₂ wherein M represents H, Na or K.

The thickness of the magnetic recording layer as a coating film formed on the non-magnetic substrate is in the range of 0.01 to 5.0 μm. When the thickness of the magnetic recording layer is less than 0.01 μm, it may be difficult to obtain a uniform coating film therefor, resulting in uneven coating thickness. When the thickness of the magnetic recording layer is more than 5.0 μm, it may be difficult to achieve desired electromagnetic transfer characteristics owing to influence of diamagnetic field.

The mixing ratio between the composite magnetic particles and the binder resin in the magnetic recording layer is controlled such that the composite magnetic particles are present in an amount of 5 to 2000 parts by weight based on 100 parts by weight of the binder resin.

Meanwhile, the magnetic recording layer may comprise, if required, known additives generally used in magnetic recording media, such as lubricants, abrasives and antistatic agents in an amount of about 0.1 to 50 parts by weight based on 100 parts by weight of the binder resin.

In the magnetic recording medium of the present invention, a non-magnetic undercoat layer comprising non-magnetic particles and a binder resin may be formed between the non-magnetic substrate and the magnetic recording layer.

As the non-magnetic particles for the non-magnetic undercoat layer, there may be used non-magnetic inorganic particles which are usually used for non-magnetic undercoat layer of magnetic recording media. Specific examples of the non-magnetic particles include particles of hematite, iron oxide hydroxide, titanium oxide, zinc oxide, tin oxide, tungsten oxide, silicon dioxide, α-alumina, β-alumina, γ-alumina, chromium oxide, cerium oxide, silicon carbide, titanium carbide, silicon nitride, boron nitride, calcium carbonate, barium carbonate, magnesium carbonate, strontium carbonate, calcium sulfate, barium sulfate, molybdenum disulfide and barium titanate. These non-magnetic particles may be used alone or in combination of any two or more thereof. Among these non-magnetic particles, especially preferred are particles of hematite, iron oxide hydroxide and titanium oxide.

Meanwhile, in order to improve a dispersibility of the non-magnetic particles in a vehicle upon production of a non-magnetic coating material, the surface of the non-magnetic particles may be coated, if required, with a hydroxide of aluminum, an oxide of aluminum, a hydroxide of silicon, an oxide of silicon, etc. In addition, in order to improve various properties of the resulting magnetic recording medium such as light transmittance, surface resistivity, mechanical strength, surface smoothness and durability, Al, Ti, Zr, Mn, Sn, Sb, etc., may be incorporated, if required, into the non-magnetic particles.

The non-magnetic particles may have various shapes, and may include granule-shaped particles having a spherical shape, a granular shape, an octahedral shape, a hexahedral shape, a polyhedral shape, etc., acicular particles having an acicular shape, a spindle shape, a rice grain-like shape, etc., and plate-shaped particles. From the viewpoint of a good surface smoothness of the resulting magnetic recording medium, among these non-magnetic particles, preferred are those particles having an acicular shape.

The non-magnetic particles usually have an average particle diameter of 0.01 to 0.3 μm, and are usually of a granular shape or, acicular shape a plate shape.

The acicular non-magnetic particles usually have an aspect ratio of 2 to 20, whereas the plate-shaped non-magnetic particles usually have a plate ratio (average plate surface diameter/average thickness) of 2 to 50.

The non-magnetic undercoat layer preferably has a thickness (as a thickness of a coating film) of 0.2 to 10.0 μm. When the thickness of the non-magnetic undercoat layer is less than 0.2 μm, it may be difficult to improve a surface roughness of the non-magnetic substrate.

The binder resin used for production of the non-magnetic undercoat layer may be the same as that used for production of the magnetic recording layer.

The mixing ratio between the non-magnetic particles and the binder resin in the non-magnetic undercoat layer is controlled such that the non-magnetic particles are present in an amount of 5 to 2000 parts by weight based on 100 parts by weight of the binder resin.

Meanwhile, the non-magnetic undercoat layer may comprise, if required, known additive used for production of magnetic recording media, such as lubricants, abrasives and antistatic agents, in an amount of about 0.1 to 50 parts based on 100 parts by weight of the binder resin.

The magnetic recording medium comprising the non-magnetic undercoat layer according to the present invention exhibits substantially the same properties as those of the magnetic recording medium comprising no non-magnetic undercoat layer. In the magnetic recording medium comprising the non-magnetic undercoat layer according to the present invention, in particular, the surface thereof can be easily smoothened and flattened by calendering, and the running durability thereof can be improved due to the lubricant supplied from the non-magnetic undercoat layer.

### <Function>

The important point of the present invention resides in that a magnetic tape (magnetic coating film) obtained by using the magnetic metal particles which are prevented from causing agglomeration therebetween in spite of fine particles having an average major axis diameter as small as 5 to 100 nm exhibits excellent magnetic properties (coercive force Hc).

Thus, the present invention aims at obtaining fine magnetic metal particles having an average major axis diameter of 5 to 100 nm. In general, finer particles tend to suffer from sintering and agglomeration therebetween. In order to prevent occurrence of sintering between the particles, different kinds of metals such as aluminum have been conventionally incorporated into the particles. However, these different kinds of elements incorporated into the particles are present in a large amount due to the fine particles. As a result, the resulting magnetic metal particles tend to comprise some particles which do not contribute to improvement in magnetic properties of magnetic recording media.

On the other hand, in the present invention, under the conditions for production of goethite particles, the oxidizing agent is used before initiation of the oxidation reaction to generate uniform goethite seed crystal particles, followed by growth reaction of the particles. Therefore, the resulting goethite particles which are minimized in inclusion of ultrafine particles therein and kept in a more uniformly grown state, can be converted into hematite particles. Thereafter, the hematite particles are subjected to heat-reduction treatment to obtain the magnetic metal particles. For this reason, the resulting magnetic metal particles are minimized in inclusion of ultrafine particles therein, and as a result, can exhibit a high coercive force required as magnetic metal particles.

The magnetic coating film (magnetic tape) produced by using the magnetic metal particles of the present invention comprises no finer particles which do not contribute to improvement in magnetic properties thereof, and behavior particles thereof have a uniform particle size distribution, thereby providing a magnetic recording medium having excellent magnetic properties (coercive force Hc).

The magnetic metal particles of the present invention exhibit a high coercive force Hc in spite of fine particles having an average major axis diameter of 5 to 100 nm and are, therefore, suitable as magnetic particles for production of magnetic recording media satisfying a high output and a high C/N ratio in a short wavelength region.

The magnetic metal particles obtained by the production process of the present invention can provide a magnetic coating film having excellent magnetic properties (coercive force Hc) in spite of fine particles having an average major axis diameter of 5 to 100 nm and are, therefore, suitable as magnetic particles for production of magnetic recording media capable of exhibiting a high output and a high C/N ratio in a short wavelength region in which a magneto-resistance head is used as a reproduction head.

### EXAMPLES

Typical examples and embodiments of the present invention are as follows.

The average major axis diameter, average minor axis diameter and aspect ratio of the goethite particles, hematite particles and magnetic metal particles as used or produced in the present invention were respectively expressed by an average of numerical values measured from a transmission electron micrograph.

Upon observing a sample by an electron microscope, the sample was produced by the following method.

That is, 0.04 parts by weight of the magnetic metal particles, 0.12 parts by weight of a dispersant and 99.84 parts by weight of a dispersing medium (dispersing solvent) were treated by an ultrasonic dispersing apparatus for a period of 30 min to obtain a dispersion.

The resulting dispersion was placed on a mesh as a supporting film for the sample and naturally dried, and then the dried sample was observed. As a result, the particles thus observed were uniformly dispersed on the sample supporting film and kept in a deaggregated state due to the preliminary dispersion.

As described above, the degree of denseness of the magnetic metal particles is expressed by the ratio of S_{BET}/S_{TEM} wherein S_{BET} is a specific surface area as measured by BET method, and S_{TEM} is a value calculated according to the following formula assuming that the particles measured on the electron micrograph are each of a rectangular parallelepiped shape having an average major axis diameter of 1 cm and an average minor axis diameter w cm.

S_{TEM}(m²/g)=[(4lw+2w²)/(lw²·ρₚ)]×10⁻⁴

wherein ρₚ is a true specific gravity of the magnetic metal particles for which 5.5 g/cm³ as a value measured by a multi-volume density meter (manufactured by Shimadzu Seisakusho Co., Ltd.) is used.

The contents of Co, Al, rare earth element, Na, Ca and other metal elements in the goethite particles, hematite particles and magnetic metal particles as used or produced in the present invention, were measured using an inductively coupled plasma atomic emission spectroscope (“SPS4000” manufactured by Seiko Denshi Kogyo Co., Ltd.).

The BET specific surface area value of the goethite particles, hematite particles and magnetic metal particles as used or produced in the present invention is expressed by the value measured by BET method using “Monosorb MS-11” (manufactured by Cantachrom Co., Ltd.).

The crystallite size D₁₁₀ of particles (X-ray crystal grain size of the magnetic metal particles) is expressed by the thickness of crystallite in the direction perpendicular to each crystal plane (110) of the magnetic metal particles as measured by X-ray diffraction method using a “X-ray diffraction apparatus” (manufactured by Rigaku Corporation) under the following conditions: target: Cu; tube voltage: 40 kV; tube current: 40 mA. The crystallite size D₁₁₀ was calculated based on the X-ray diffraction peak curve prepared with respect to each crystal plane by using the following Scherrer's formula:

D₁₁₀=Kλ/β cos θ

wherein β is a true half-width of the diffraction peak which was corrected with respect to a width of a machine used (unit: radian); K is a Scherrer constant (=0.9); λ is a wavelength of X-ray used (Cu Kα-ray 0.1542 nm); and θ is a diffraction angle (corresponding to a diffraction peak of crystal plane (110)).

The magnetic properties of the magnetic metal particles and magnetic coating film piece were measured using a vibration sample magnetometer “VSM-3S-15” (manufactured by Toei Kogyo Co., Ltd.) by applying an external magnetic field of 795.8 kA/m (10 kOe) thereto.

The magnetic properties of the magnetic coating film piece were measured by the following method.

The respective components as shown below were charged into a 140 mL plastic bottle, and then mixed and dispersed for 8 hr using a paint shaker (manufactured by Reddevil Co., Ltd.), thereby preparing a magnetic coating composition. The thus prepared magnetic coating composition was coated on a 25 μm-thick polyethylene terephthalate film using an applicator to form a coating layer having a thickness of 50 μm thereon. The obtained coating film was then dried in a magnetic field of 500 mT (5 kGauss), thereby obtaining a magnetic coating film piece. The magnetic properties of the thus obtained magnetic coating film piece were measured.

### Coating Composition

| | | |
|---|---|---|
| Magnetic metal particles: | 100 | parts by weight |
| Vinyl chloride-based copolymer resin having | 10 | parts by weight |
| a potassium sulfonate group: | | |
| Polyurethane resin having a sodium sulfonate | 10 | parts by weight |
| group: | | |
| Abrasive (AKP-50): | 10 | parts by weight |
| Lubricant (myristic acid/butyl stearate: | 3 | parts by weight |
| 1/2): | | |
| Curing agent (polyisocyanate): | 5 | parts by weight |
| Cyclohexanone | 65.8 | parts by weight |
| Methyl ethyl ketone: | 164.5 | parts by weight |
| Toluene: | 98.7 | parts by weight |

The Δσs value showing an oxidation stability of saturation magnetization of the magnetic metal particles, and the ΔBm value showing a weather resistance of saturation magnetic flux density (Bm) of the magnetic coating film were measured as follows.

The particles or the magnetic coating film piece were placed in a thermostatic chamber maintained at 60° C. and a relative humidity of 90%, and allowed to stand therein for one week to conduct an accelerated deterioration test. Thereafter, the particles or the magnetic coating film piece were measured to determine the saturation magnetization value (σs′) and saturation magnetic flux density (Bm′), respectively. The oxidation stability values Δσs and ΔBm were calculated by dividing the difference (absolute value) between the σs and σs′ values measured before and after the one-week accelerated test, and the difference (absolute value) between the Bm and Bm′ values measured before and after the one-week accelerated test, by the values as and Bm measured before the accelerated test, respectively. The closer to zero the Δσs and ΔBm values, the more excellent the oxidation stability.

### Example 1

28 L of a mixed alkali aqueous solution comprising ammonium carbonate and aqueous ammonia in amounts of 20 mol and 60 mol (concentration of the ammonium hydroxide aqueous solution corresponds to 75 mol % in terms of normality based on mixed alkalis), respectively, was charged into a reaction tower equipped with a stirrer having bubble dispersing blades, and heated to 50° C. while rotating the stirrer at 700 rpm and passing a nitrogen gas at a flow rate of 60 L/min through the reaction tower. Then, 16 L of a ferrous sulfate aqueous solution comprising 20 mol of Fe²⁺ (concentration of the mixed alkali aqueous solution corresponds to 3.75 equivalents in terms of normality based on ferrous sulfate) was charged into the bubble tower, and the contents of the bubble tower were aged therein for 30 min. Thereafter, 4 L of a cobalt sulfate aqueous solution comprising 6.0 mol of Co²⁺ (corresponding to 30 atom % in terms of Co based on whole Fe) was added to the bubble tower and the contents of the bubble tower were further aged for 2.5 hr.

Next, while rotating the stirrer at 450 rpm, an ammonium peroxodisulfate aqueous solution as an oxidizing agent (in an amount of 3.6% based on whole Fe) was added to the reactor, and the contents in the reactor were allowed to stand for 10 min for obtaining a uniform mixture. Thereafter, air was passed through the reactor at a flow rate of 0.821 L/min to conduct the oxidation reaction until the oxidation percentage of whole Fe²⁺ reached 30%.

Then, 1 L of an aluminum sulfate aqueous solution comprising 1.6 mol of Al³⁺ corresponding to 8 atom % in terms of Al based on whole Fe) was added to the reactor, and the oxidation reaction was continued until completion of the reaction while passing air therethrough at a flow rate of 0.82 L/min. It was confirmed that the pH value of the reaction solution upon termination of the reaction was 8.3.

The thus obtained slurry comprising goethite particles was filtered by an ordinary method to separate the goethite particles therefrom, and the thus separated goethite particles were washed with water and then re-dispersed in water, followed by adding a cobalt acetate aqueous solution (Co content: 10 atom % based on whole Fe) to the resulting dispersion and sufficiently stirring the mixture. Next, while stirring the mixture, a sodium carbonate aqueous solution was added thereto to adjust a pH value of the resulting aqueous solution to 8.8. Then, a yttrium nitrate aqueous solution (yttrium content: 22 atom % based on whole Fe) was added to the aqueous solution, and the resulting slurry was mixed under stirring. Further, a sodium carbonate aqueous solution was added to the slurry to adjust a pH value of the slurry to 9.3. Thereafter, the slurry was filtered to separate the particles therefrom, and the thus separated particles were washed with water and then dried, thereby obtaining a dried solid product of goethite particles.

It was confirmed that the obtained goethite particles had an average major axis diameter of 0.077 μm, an aspect ratio of 7.8, a BET specific surface area of 201.0 m²/g, a Co content of 40 atom % based on whole Fe, an Al content of 8 atom % based on whole Fe, and a Y content of 21 atom % based on whole Fe.

The thus obtained solid product of the goethite particles was dehydrated in air at 350° C., and then heat-dehydrated at 500° C. in the same atmosphere, thereby obtaining a solid product of hematite particles.

### <Heat-Reduction Treatment>

Next, 100 g of the thus obtained granule-shaped granulated product (average diameter: 2.6 mm) of the spindle-shaped hematite particles were charged into a reducing apparatus of a batch fixed bed type having an inner diameter of 72 mm so as to form a fixed bed having a height of 7 cm. Thereafter, the heat reduction reaction was conducted at 350° C. while passing a hydrogen gas at a superficial velocity of 50 cm/s until the dew point of exhaust gas reached −30° C., thereby obtaining magnetic metal particles.

Then, after replacing the hydrogen gas with a nitrogen gas again, the obtained particles were cooled to 80° C. and maintained at that temperature. Successively, air was mixed with the nitrogen gas, and the amount of air mixed was gradually increased until the oxygen concentration of the mixed gas reached 0.35 vol %. Under such an atmosphere, the particles were subjected to surface oxidation treatment until the temperature thereof reached the retention temperature plus 1° C. (maximum temperature of particles: 140° C.; treating time: 2 hr), thereby forming a surface oxidation layer on the surface of the respective particles.

Next, the resulting particles were heated to 600° C. in a hydrogen gas atmosphere, and the heat reduction reaction was conducted again at 600° C. while passing a hydrogen gas therethrough at a superficial velocity of 60 cm/s until the dew point of exhaust gas reached −30° C.

Then, after replacing the hydrogen gas with a nitrogen gas again, the obtained particles were cooled to 80° C. and maintained at that temperature. Successively, 6 g/m³ of water vapor and air was mixed with the nitrogen gas, and the amount of air mixed was gradually increased until the oxygen concentration of the mixed gas reached 0.35 vol %. Under such an atmosphere, the particles were subjected to surface oxidation treatment until the temperature thereof reached the retention temperature plus 1° C. (maximum temperature of particles: 110° C.; treating time: 3 hr), thereby forming a surface oxidation layer on the surface of the respective particles and producing a molded product of magnetic metal particles.

It was confirmed that the thus obtained magnetic metal particles had an average major axis diameter of 0.039 μm, an aspect ratio of 4.2, a BET specific surface area of 79.0 m²/g and a crystallite size D₁₁₀ of 99.0 Å, and were spindle-shaped particles having a uniform particle size and comprising no dendritic particles. In addition, it was confirmed that the magnetic metal particles had a Co content of 40 atom % based on whole Fe; an Al content of 8 atom % based on whole Fe; and a Y content of 21 atom % based on whole Fe.

As to the magnetic properties of the magnetic metal particles, the coercive force Hc thereof was 187.0 kA/m (2,350 Oe); the saturation magnetization value σs thereof was 98.9 Am²/kg (98.9 emu/g); the squareness (σr/σs) thereof was 0.535; and the oxidation stability (Δσs) of saturation magnetization thereof was 15.2%.

As to the magnetic properties of the magnetic coating film, the coercive force Hc thereof was 2,573 Oe; the squareness (Br/Bm) thereof was 0.832; the S.F.D. thereof was 0.57; and the oxidation stability (ΔBm) thereof was 6.2%.

In addition, various properties of the obtained magnetic metal particles are shown in Table 2, and various properties of the magnetic tapes produced by using the magnetic metal particles are shown in Table 3.

### Examples 2 and 11 and Comparative Examples 1 to 6

The same procedure as defined in Example 1 for production of goethite particles was conducted except that kind and amount of the oxidizing agent added, neutralization temperature, time of addition of the Al compound as well as amount of the Al compound added, and oxidation reaction rate were changed variously, thereby obtaining goethite particles. Essential production conditions and various properties of the obtained goethite particles are shown in Table 1.

TABLE 1

| | Production conditions | | |
|---|---|---|---|
| | | Amount of | |
| Examples and | | oxidizing | Neutralization |
| Comparative | Kind of | agent added | temperature |
| Examples | oxidizing agent | (mol %) | (° C.) |
| Example 1 | Ammonium | 1.8 | 50 |
| | peroxodisulfate | | |
| Example 2 | Ammonium | 0.5 | 50 |
| | peroxodisulfate | | |
| Example 3 | Ammonium | 1.3 | 50 |
| | peroxodisulfate | | |
| Example 4 | Ammonium | 2.6 | 50 |
| | peroxodisulfate | | |
| Example 5 | Ammonium | 3.5 | 50 |
| | peroxodisulfate | | |
| Example 6 | Ammonium | 1.6 | 58 |
| | peroxodisulfate | | |
| Example 7 | Ammonium | 1.7 | 40 |
| | peroxodisulfate | | |
| Example 8 | Ammonium | 1.7 | 45 |
| | peroxodisulfate | | |
| Example 9 | Ammonium | 1.6 | 50 |
| | peroxodisulfate | | |
| Example 10 | Ammonium | 3.5 | 40 |
| | peroxodisulfate | | |
| Example 11 | Ammonium | 1.8 | 50 |
| | peroxodisulfate | | |
| Comparative | None | — | 50 |
| Example 1 | | | |
| Comparative | Air | — | 50 |
| Example 2 | | | |
| Comparative | Air | — | 50 |
| Example 3 | | | |
| Comparative | H₂O₂ | 1.3 | 50 |
| Example 4 | | | |
| Comparative | H₂O₂ | 7.5 | 50 |
| Example 5 | | | |
| Comparative | H₂O₂ | 5.0 | 50 |
| Example 6 | | | |

| | Production conditions | | |
|---|---|---|---|
| | Time of | | Amount of Al |
| Examples and | addition of Al | Air oxidation | charged |
| Comparative | (oxidation | reaction rate | (Al/(Fe + Co)) |
| Examples | percentage) (%) | (l/min) | (atom %) |
| Example 1 | 30 | 0.82 | 8 |
| Example 2 | 50 | 0.64 | 8 |
| Example 3 | 60 | 0.85 | 8 |
| Example 4 | 40 | 0.94 | 8 |
| Example 5 | 30 | 3.62 | 8 |
| Example 6 | 35 | 0.82 | 17 |
| Example 7 | 35 | 2.48 | 19 |
| Example 8 | 20 | 0.88 | 19 |
| Example 9 | 60 | 2.48 | 8 |
| Example 10 | 40 | 3.00 | 8 |
| Example 11 | 30 | 0.82 | 36 |
| Comparative | 30 | 0.82 | 8 |
| Example 1 | | | |
| Comparative | 30 | 1.00 | 8 |
| Example 2 | | | |
| Comparative | 30 | 3.62 | 20 |
| Example 3 | | | |
| Comparative | 30 | 0.82 | 8 |
| Example 4 | | | |
| Comparative | 30 | 0.82 | 20 |
| Example 5 | | | |
| Comparative | 30 | 0.82 | 4 |
| Example 6 | | | |

| | Properties of goethite particles | | |
|---|---|---|---|
| Examples and | Average major | Average | |
| Comparative | axis diameter | aspect ratio | BET |
| Examples | (nm) | (-) | (m²/g) |
| Example 1 | 77.4 | 7.8 | 201.0 |
| Example 2 | 86.8 | 7.0 | 167.9 |
| Example 3 | 82.8 | 6.9 | 183.3 |
| Example 4 | 66.2 | 8.5 | 242.8 |
| Example 5 | 58.0 | 8.1 | 238.6 |
| Example 6 | 77.6 | 7.9 | 202.2 |
| Example 7 | 71.8 | 8.0 | 231.0 |
| Example 8 | 63.5 | 8.3 | 230.4 |
| Example 9 | 77.8 | 7.4 | 216.8 |
| Example 10 | 48.5 | 8.6 | 226.4 |
| Example 11 | 73.6 | 6.9 | 267.9 |
| Comparative | 104.0 | 6.2 | 166.6 |
| Example 1 | | | |
| Comparative | 109.2 | 7.4 | 170.3 |
| Example 2 | | | |
| Comparative | 118.8 | 7.8 | 207.9 |
| Example 3 | | | |
| Comparative | 108.2 | 6.4 | 220.1 |
| Example 4 | | | |
| Comparative | 86.9 | 8.3 | 267.2 |
| Example 5 | | | |
| Comparative | 94.4 | 7.6 | 251.0 |
| Example 6 | | | |

Next, the same procedure as defined in Example 1 for production of magnetic metal particles was conducted except that the kinds of goethite particles used as the raw material were changed variously, thereby obtaining magnetic metal particles.

Various properties of the obtained magnetic metal particles are shown in Table 2, and various properties of the magnetic tapes produced by using the magnetic metal particles are shown in Table 3.

TABLE 2

| Examples and | Properties of magnetic metal particles | | | |
|---|---|---|---|---|
| Comparative | | Co/Fe | Al/Fe | Y/Fe |
| Examples | Particle shape | (atom %) | (atom %) | (atom %) |
| Example 1 | Spindle shape | 40 | 8 | 21 |
| Example 2 | Spindle shape | 40 | 8 | 22 |
| Example 3 | Spindle shape | 40 | 8 | 22 |
| Example 4 | Spindle shape | 40 | 8 | 22 |
| Example 5 | Spindle shape | 40 | 8 | 22 |
| Example 6 | Spindle shape | 40 | 17 | 21 |
| Example 7 | Spindle shape | 40 | 19 | 20 |
| Example 8 | Spindle shape | 39 | 19 | 22 |
| Example 9 | Spindle shape | 38 | 8 | 22 |
| Example 10 | Spindle shape | 39 | 8 | 22 |
| Example 11 | Spindle shape | 39 | 36 | 22 |
| Comparative | Spindle shape | 40 | 8 | 22 |
| Example 1 | | | | |
| Comparative | Spindle shape | 40 | 8 | 8 |
| Example 2 | | | | |
| Comparative | Spindle shape | 40 | 20 | 21 |
| Example 3 | | | | |
| Comparative | Spindle shape | 40 | 8 | 21 |
| Example 4 | | | | |
| Comparative | Spindle shape | 40 | 20 | 21 |
| Example 5 | | | | |
| Comparative | Spindle shape | 40 | 4 | 21 |
| Example 6 | | | | |

| | Properties of magnetic metal particles | | |
|---|---|---|---|
| Examples and | Average major | Average minor | Average aspect |
| Comparative | axis diameter | axis diameter | ratio |
| Examples | (nm) | (nm) | (-) |
| Example 1 | 38.7 | 9.20 | 4.2 |
| Example 2 | 52.1 | 13.4 | 3.9 |
| Example 3 | 47.2 | 11.2 | 4.2 |
| Example 4 | 29.8 | 8.3 | 3.6 |
| Example 5 | 25.5 | 8.2 | 3.1 |
| Example 6 | 38.8 | 9.5 | 4.1 |
| Example 7 | 35.9 | 9.4 | 3.8 |
| Example 8 | 30.5 | 8.0 | 3.8 |
| Example 9 | 38.9 | 9.3 | 4.2 |
| Example 10 | 18.9 | 6.3 | 3.0 |
| Example 11 | 36.8 | 9.5 | 3.9 |
| Comparative | 52.0 | 12.1 | 4.3 |
| Example 1 | | | |
| Comparative | 53.3 | 12.4 | 4.3 |
| Example 2 | | | |
| Comparative | 58.4 | 13.0 | 4.5 |
| Example 3 | | | |
| Comparative | 48.7 | 12.2 | 4.0 |
| Example 4 | | | |
| Comparative | 39.1 | 9.3 | 4.2 |
| Example 5 | | | |
| Comparative | 40.6 | 9.7 | 4.2 |
| Example 6 | | | |

| | Properties of magnetic metal particles | | | |
|---|---|---|---|---|
| Examples and | Crystallite | BET specific | Degree of | Coercive |
| Comparative | size D₁₁₀ | surface area | denseness | force Hc |
| Examples | (Å) | (m²/g) | (S_{BET}/S_{TEM}) | (Oe) |
| Example 1 | 99 | 79.0 | 1.39 | 2350 |
| Example 2 | 127 | 72.0 | 1.42 | 2550 |
| Example 3 | 123 | 76.6 | 1.28 | 2525 |
| Example 4 | 93 | 85.0 | 1.35 | 1975 |
| Example 5 | 90 | 93.0 | 1.41 | 1887 |
| Example 6 | 109 | 91.4 | 1.37 | 2417 |
| Example 7 | 99 | 78.9 | 1.40 | 2290 |
| Example 8 | 96 | 101.0 | 1.38 | 2317 |
| Example 9 | 99 | 100.0 | 1.36 | 2275 |
| Example 10 | 88 | 99.9 | 1.35 | 1689 |
| Example 11 | 101 | 121.0 | 1.36 | 2310 |
| Comparative | 120 | 79.8 | 2.68 | 2430 |
| Example 1 | | | | |
| Comparative | 121 | 83.2 | 2.71 | 2388 |
| Example 2 | | | | |
| Comparative | 125 | 72 | 3.21 | 2408 |
| Example 3 | | | | |
| Comparative | 126 | 83.2 | 2.02 | 2259 |
| Example 4 | | | | |
| Comparative | 105 | 82.7 | 2.95 | 1850 |
| Example 5 | | | | |
| Comparative | 99 | 82.6 | 2.41 | 1719 |
| Example 6 | | | | |

| | Properties of magnetic metal particles | | |
|---|---|---|---|
| | | | Oxidation |
| Examples and | Saturation | Squareness | stability |
| Comparative | magnetization | (r/s) | (Δσs) |
| Examples | (σs) (emu/g) | (-) | (%) |
| Example 1 | 98.9 | 0.535 | 15.2 |
| Example 2 | 118.0 | 0.539 | 8.6 |
| Example 3 | 113.0 | 0.534 | 7.3 |
| Example 4 | 98.4 | 0.526 | 13.3 |
| Example 5 | 96.6 | 0.513 | 17.0 |
| Example 6 | 104.3 | 0.535 | 9.3 |
| Example 7 | 102.8 | 0.535 | 16.3 |
| Example 8 | 97.6 | 0.523 | 11.5 |
| Example 9 | 95.7 | 0.515 | 12.0 |
| Example 10 | 90.1 | 0.492 | 19.1 |
| Example 11 | 93.8 | 0.515 | 17.8 |
| Comparative | 116.5 | 0.505 | 7.4 |
| Example 1 | | | |
| Comparative | 112.7 | 0.516 | 9.4 |
| Example 2 | | | |
| Comparative | 118.6 | 0.532 | 19.1 |
| Example 3 | | | |
| Comparative | 108.6 | 0.530 | 8.9 |
| Example 4 | | | |
| Comparative | 104.6 | 0.470 | 19.8 |
| Example 5 | | | |
| Comparative | 99.7 | 0.505 | 11.9 |
| Example 6 | | | |

TABLE 3

| | Properties of magnetic coating film | | |
|---|---|---|---|
| Examples and | Coercive | | |
| Comparative | force Hc | Squareness | SFD |
| Examples | (Oe) | (-) | (-) |
| Example 1 | 2573 | 0.832 | 0.57 |
| Example 2 | 2730 | 0.832 | 0.55 |
| Example 3 | 2690 | 0.848 | 0.44 |
| Example 4 | 2163 | 0.818 | 0.66 |
| Example 5 | 2111 | 0.790 | 0.70 |
| Example 6 | 2632 | 0.823 | 0.62 |
| Example 7 | 2474 | 0.822 | 0.56 |
| Example 8 | 2580 | 0.838 | 0.60 |
| Example 9 | 2517 | 0.823 | 0.59 |
| Example 10 | 1879 | 0.770 | 0.74 |
| Example 11 | 2528 | 0.828 | 0.69 |
| Comparative | 2620 | 0.818 | 0.54 |
| Example 1 | | | |
| Comparative | 2303 | 0.822 | 0.64 |
| Example 2 | | | |
| Comparative | 2490 | 0.795 | 0.83 |
| Example 3 | | | |
| Comparative | 2454 | 0.824 | 0.58 |
| Example 4 | | | |
| Comparative | 2109 | 0.761 | 0.74 |
| Example 5 | | | |
| Comparative | 1898 | 0.777 | 0.82 |
| Example 6 | | | |

Properties of magnetic coating film

| Examples and | | Oxidation stability |
|---|---|---|
| Comparative | Surface roughness Ra | (ΔBm) |
| Examples | (nm) | (%) |
| Example 1 | 3.9 | 6.2 |
| Example 2 | 3.6 | 5.5 |
| Example 3 | 3.4 | 5.8 |
| Example 4 | 4.0 | 7.9 |
| Example 5 | 4.2 | 8.1 |
| Example 6 | 3.7 | 7.2 |
| Example 7 | 4.1 | 7.6 |
| Example 8 | 4.0 | 8.3 |
| Example 9 | 3.7 | 6.9 |
| Example 10 | 4.3 | 9.9 |
| Example 11 | 4.1 | 10.1 |
| Comparative | 4.4 | 6.0 |
| Example 1 | | |
| Comparative | 5.2 | 7.3 |
| Example 2 | | |
| Comparative | 5.7 | 9.5 |
| Example 3 | | |
| Comparative | 5.9 | 6.0 |
| Example 4 | | |
| Comparative | 6.8 | 9.1 |
| Example 5 | | |
| Comparative | 6.1 | 8.7 |
| Example 6 | | |

As apparently understood from the results of the above Examples and Comparative Examples, it was confirmed that the magnetic metal particles produced by the process of the present invention exhibited a high coercive force despite of small particle size thereof. For example, from the comparison between Example 3 and Comparative Example 4 in which the magnetic metal particles having a similar average major axis diameter were used, it was apparently recognized that the particles obtained in Example 3 exhibited a higher coercive force than those obtained in Comparative Example 4.

What is claimed is:

1. A process for producing magnetic metal particles for magnetic recording, comprising:
heat-treating goethite particles having an aluminum content of 4 to 50 atom % in terms of Al based on whole Fe to obtain hematite particles; and
heat-reducing the hematite particles at a temperature of 200 to 600° C.,
the goethite particles being obtained by adding a peroxodisulfate to a reaction solution comprising:
a ferrous salt aqueous solution and
a mixed alkali aqueous solution comprising:
an alkali hydrogen carbonate aqueous solution or alkali carbonate aqueous solution and
an alkali hydroxide aqueous solution before initiation of an oxidation reaction of the reaction solution, and then conducting the oxidation reaction.

2. A process according to claim 1, wherein the goethite particles comprise Co in an amount of 10 to 50 atom % based on whole Fe.

3. A process according to claim 2, wherein a surface of the goethite particles produced is coated with a rare earth compound and/or a Co compound, and then the thus coated goethite particles are subjected to the heat treatment.

4. A process according to claim 3, wherein the rare earth compound is used such that a coating amount thereof is 10 to 30 atom % in terms of rare earth element based on whole Fe.

5. A process according to claim 3, wherein the Co compound is used such that a coating amount thereof is 20 to 200 atom % in terms of Co based on whole Co contained in the goethite particles before the coating treatment.

6. A process according to claim 1, wherein the peroxodisulfate is added in an amount of 0.5 to 5 mol % in terms of peroxodisulfate based on whole Fe.

7. A process according to claim 1, wherein the peroxodisulfate is ammonium peroxodisulfate.

8. A magnetic recording medium, comprising:
a non-magnetic substrate;
a non-magnetic undercoat layer formed on the non-magnetic substrate, comprising non-magnetic particles and a binder resin; and
a magnetic recording layer formed on the non-magnetic undercoat layer, comprising magnetic particles and a binder resin,
the magnetic metal particles for magnetic recording produced by the process as defined in claim 1 being used as the magnetic particles.
